(19) United States
(12) Patent Application Publication
(10) Pub. No.: US 2022/0012771 A1
(43) Pub. Date: Jan. 13, 2022

(54) METHOD AND SYSTEM FOR CLICK INSPECTION

(71) Applicant: Revtech Ltd., Navan (IE)

(72) Inventors: Ahlam Maria Therese Gustafson, Tel Aviv (IL); Zen Donegan, Navan (IE)

(21) Appl. No.: 17/369,971

(22) Filed: Jul. 8, 2021

Related U.S. Application Data
(60) Provisional application No. 63/049,177, filed on Jul. 8, 2020.

(51) Int. Cl. G06Q 30/02; G06F 16/955

(52) U.S. Cl. CPC G06Q 30/0248; H04L 67/32; G06F 16/9558

(57) ABSTRACT

A computerized method and system for filtering traffic associated with clicks associated with an activatable link in electronic content, is such that when certain suspicious traffic from the activatable link is detected, the traffic is terminated and does not reach the target web site associated with the electronic content.

### CROSS REFERENCES TO RELATED APPLICATIONS

This application is related to and claims priority from commonly owned U.S. Provisional Patent Application Ser. No. 63/049,177, entitled: METHOD AND SYSTEM FOR CLICK INSPECTION, filed on Jul. 8, 2020, the disclosure of which is incorporated by reference in its entirety herein.

### TECHNICAL FIELD

The present disclosure is directed to methods and systems for click filtration.

### BACKGROUND

In on-line advertising and information providing, a recipient typically receives content, provided by an information or content provider or party associated therewith, that when activated, or “clicked on”, contacted, swiped or the like (collectively known as “clicks”) by the recipient, the recipient's browser is directed to the target web site associated with the content. However, sometimes, bots and other malicious actors also obtain access to the content and produce multiple “clicks” on the content which are fraudulent. The information/content provider must pay for these fraudulent clicks, in addition to the legitimate clicks, from legitimate users, which caused the information or content providers budget to be spent quickly.

### SUMMARY OF THE INVENTION

Embodiments of the present invention provide methods and systems which allow for clicks to be filtered, with fraudulent clicks detected, and the communication terminated between the entity which made the fraudulent click and the target server associated with the content provider. This way, the content provider is not charged for the fraudulent click, e.g., the communication, that never reached the target server, as the communication was terminated by the system of the invention. As a result, the content provider's budget is not rapidly depleted by fraudulent clicks, as the clicks never reach the target server of the content provider.

Embodiments of the present invention provide a computerized method for filtering traffic associated with clicks associated with an activatable link in electronic content, such that certain suspicious traffic from the activatable link is terminated and does not reach the target web site associated with the electronic content.

Embodiments of the present invention provide for computerized methods and systems for filtering traffic associated with clicks associated with an activatable link in electronic content, such that when certain suspicious traffic from the activatable link is detected, the traffic is terminated and does not reach the target web site associated with the electronic content.

This document references terms that are used consistently or interchangeably herein. These terms, including variations thereof, are as follows.

Throughout this document, a “web site” is a related collection of World Wide Web (WWW) files that includes a beginning file or “web page” called a home page, and typically, additional files or “web pages.” The term “web site” is used collectively to include “web site” and “web page(s).”

A uniform resource locator (URL) is the unique address for a file, such as a web site or a web page that is accessible over Networks including the Internet.

“n” and “n^{th}” in the description below and the drawing figures represents the last member of a series or sequence of members, such as elements, computers, servers, databases, caches, components, listings, links, data files, etc.

A “computer” includes machines, computers and computing or computer systems (for example, physically separate locations or devices), servers, computer and computerized devices, processors, processing systems, computing cores (for example, shared devices), and similar systems, workstations, modules and combinations of the aforementioned. The aforementioned “computer” may be in various types, such as a personal computer e.g., laptop, desktop, tablet computer), or any type of computing device, including mobile devices that can be readily transported from one location to another location (e.g., smart phone, personal digital assistant (PDA), mobile telephone or cellular telephone).

A “server” is typically a remote computer or remote computer system, or computer program therein, in accordance with the “computer” defined above, that is accessible over a communications medium, such as a communications network or other computer network, including the Internet. A “server” provides services to, or performs functions for, other computer programs (and their users), in the same or other computers. A server may also include a virtual machine, a software based emulation of a computer.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a diagram of an exemplary environment for the system in which embodiments of the disclosed subject matter are performed;

FIG. 2 is a block diagram of a system architecture for an example system which performs the processes of the disclosed subject matter; and,

FIGS. 3A and 3B, collectively known as FIG. 3, are a flow diagram of an example process performed by the system of the invention.

### DETAILED DESCRIPTION OF THE DRAWINGS

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more non-transitory computer readable (storage) medium(s) having computer readable program code embodied thereon.

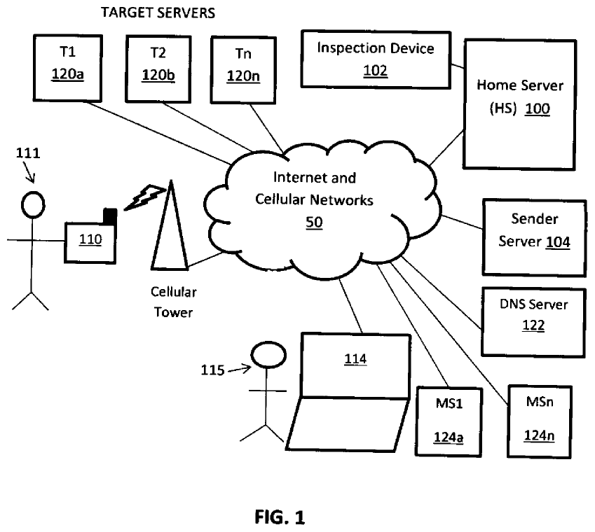

Reference is now made to FIG. 1, which shows an exemplary operating environment, including a network(s) 50 (hereinafter “network”), to which is linked a home server (HS) 100, also known as a home computer, a main server or main computer, these terms used interchangeably herein. The home server 100 communicates with an inspection device 102, by wired and/or wireless links, to form a system 200, which may also include other, computers, including servers, and/or components, for performing the processes of invention. The network 50 is, for example, a communications network, such as a Local Area Network (LAN), or a Wide Area Network (WAN), including public networks such as the Internet, and/or cellular networks. As shown in FIG. 1, the network 50 is, for example, the Internet and cellular networks. “Linked” as used herein includes both wired or wireless links, either direct or indirect, and placing the computers, including, servers, components and the like, in electronic and/or data communications with each other.

The home server 100 is, for example, such that it opens connections between computers over the network 50, subjects traffic to filtering, allows traffic to proceed or terminates traffic, and gathers user impression and click data, regardless of whether or not the traffic associated therewith was terminated. The home server 100, for example, links to an inspection device 102, which for example, filters traffic, detects bots, which may have made the click, detects other malicious traffic, and accommodates specific blocking requests, such as clicks and associated traffic coming from countries, regions or the like, as decided by the content provider, system administrator, or the like.

A sender server 104, for example, associated with the impression/content provider, typically sends impressions with the content provider's content to users, such as the smart phone 110 of the user 111 and the computer 114 of the user 115. The impression sent includes one or more activatable links, each activatable link, that when activated by being clicked on (by the recipient user), redirects the computer's browser to the target web site of a target server (T1-TN) 120a-120n, associated with the content provider. Each activatable link includes the URL of the target web site, associated with the content provider, as well being mapped to the Home Server 100 (or system 200).

When the activatable link is activated by the recipient user, the home server 100, by virtue of the activatable link mapped to it, opens a connection between the user, e.g., user 111 (via device 110) and the DNS server 122. Prior to the traffic or click reaching the DNS server 122, the home server 100 intercepts the click and/or the associated traffic, and inspects it, to see if the click and associated traffic are legitimate. The inspection is performed either in the home server 100, the inspection device 102, or both. Should the click and/or associated traffic not pass the filtering, the click may be determined to be fraudulent, a bot (machine) may be suspected as having made the click, the click and/or associated traffic is malicious, or other factors programmed into the home server 100 and/or the inspection device 102, such that the click is not legitimate. As a result of the click being not legitimate, for one of more of the above listed, the home server 100 terminates the traffic, so it never gets to the DNS server 122, and subsequently, the destination, such as a target web site, hosted on a target server 120a-120n, over the network 50. Should the traffic be acceptable or legitimate to the home server 100 and inspection device 102, it passes to the DNS server 122, where the domain names associated with the traffic are resolved, and the traffic, if legitimate, proceeds to the requisite target web site of the server (T1-Tn) 120a-120n. There are also mitigation servers (MS1-MSn) 124a-124n, one or more of which is used to receive redirected traffic, for example, until the attack ends or subsides, should a target server 120a-120n be determined to be under a Denial of Service (DoS) or a Distributed Denial of Service (DDoS) attack.

The home server 100, administering the content provider's account (by the accounting/accounts module 218), for example, does not charge the content provider for the fraudulent click, and the content provider's budget, administered by the home server 100 (by the accounting/accounts module 218), does not drain rapidly, due to fraudulent clicks. The home server 100 monitors all clicks and traffic, regardless of whether it is terminated or passed to the target web site (for example, represented by the target servers (T1-Tn) 120a-120n. As a result of clicks being blocked, the click does not reach its intended destination, such that the content provider (content provider's account) is not charged for the click (by the accounting/accounts module 218).

While the sender server 104 typically sends the impressions of the content provider to the users, e.g., users 111 and 115 at their respective computers/devices 112, 114, this may also be done fully or partially by the home server 100.

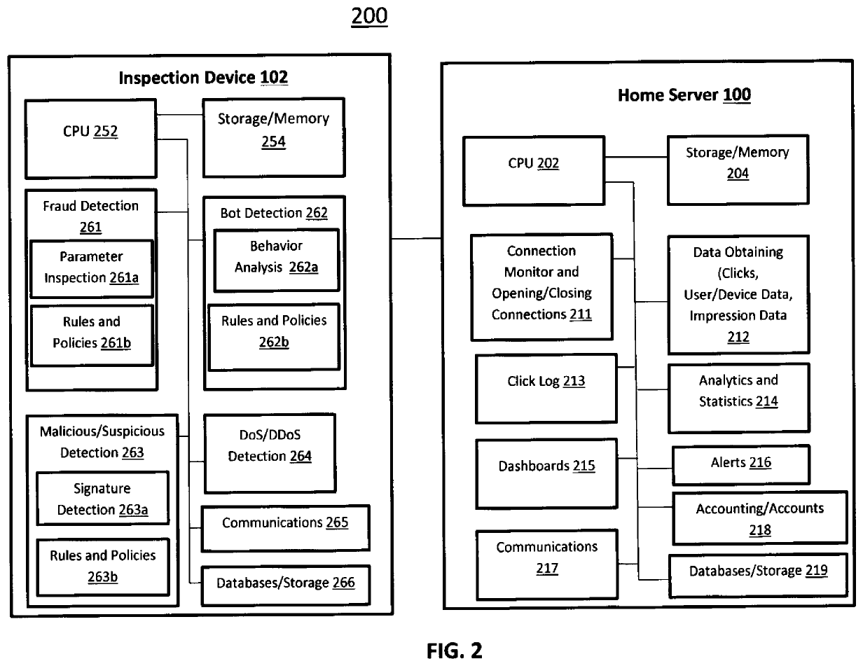

FIG. 2 is a block diagram showing the architecture of a system 200, for example, formed by the home server 100 and the inspection device 102. The home server 100, as linked to the inspection device 102, the inspection device 102 and the home server 100 combined with the inspection device 102, may also be known as an inspection computer. The system 200 is such that one or more of the components, modules, and the like, of the system 200 may be external to the home server 100 and/or the inspection device 102, including, for example, in the cloud. As used herein, a “module”, for example, includes a component for storing instructions (e.g., machine readable instructions) for performing one or more processes, and including or associated with processors, e.g., the CPU 202, 252, for executing the instructions. Other components are also permissible in the system 200, and all components in the system 200 are linked to and in communication with each other, as well as other components linked to the system 200 via the network(s) 50, either directly or indirectly.

The home server 100 includes a central processing unit (CPU) 202, which is linked to storage/memory 204. The CPU 202 is linked to modules for use in click tracking and click and traffic analytics. The modules include, for example, a monitoring module 211, a data gathering module 212, a click log 213, an analytics and statistics module 214, a dashboard module 215, an Alerts module 216, a communications module 217, accounting/accounts module 218, and databases/storage 219.

The Central Processing Unit (CPU) 202 is formed of one or more processors, including microprocessors, for performing functions and operations detailed herein. The processors are, for example, conventional processors, and hardware processors, such as those used in servers, computers, and other computerized devices. For example, the processors may include x86 Processors from AMD (Advanced Micro Devices) and Intel, as well as any combinations thereof.

The storage/memory 204 stores machine executable instructions for execution by the CPU 202. The storage/memory 204 also includes storage media for temporary storage of data. The storage/memory 204 also includes machine executable instructions associated with the operation of the modules 211-218.

The monitoring module 211 monitors the network(s) 50 for clicks and traffic, which is mapped to the home server 100, and active. The monitoring module 211, upon detecting the mapped clicks and/or traffic opens connections between the computer, which has received the impression with the now active mapped clicks and/or traffic, and the home server 100. This module 211 will also close and/or terminate the connection if instructed to do so, for example, by the inspection device 102 (via the communications modules 265, 217.

The data gathering module 212 gathers or otherwise obtains data about clicks, traffic, users and impressions.

The click log 213 logs or otherwise records clicks from the various impressions, such as hovers, opens, when the activatable link of the impression is clicked on, and conversions, when the target destination, such as a web site hosted by a target server 120a-120n is interacted with. Example interaction indicative of a conversion may be when the user enters details into the web site. The click log 213 also records fraudulent and legitimate clicks.

The analytics and statistics module 214 analyzes clicks, traffic and impressions, to provide various information about various information providing, including advertising campaigns.

The dashboards module 215 creates dashboards which are viewable on screen by content providers, such as information providers, advertisers, and the like, and provides statistics on campaigns being run by the information providers, advertisers, and the like.

The alerts module 216 issues alerts to user devices, for example, of users that have received impressions, that their device browser will not be redirected to the target destination (e.g., URL associated with a target server 120a-120n), due to the click being fraudulent, malicious or suspicious.

The communications module 217 provides for communications to and from the home server 100, with the inspection device 102, as well as destinations along the network(s) 50.

The accounting/accounts module 218, provides accounting and administration for content provider accounts, such as debiting and crediting content provider's accounts based on deposits, and credits and debits from click activity.

The databases/storage 219 provide storage for data from the modules 211-218.

The inspection device 102 is, for example, a computer or computerized device, and includes a central processing unit (CPU) 252, which is linked to storage/memory 254. The CPU 252 and storage/memory 254 are similar to the CPU 202 and storage/memory 204 detailed for the home server 100, and are in accordance with those descriptions above. The storage/memory 254 also includes storage media for temporary storage of data. The storage/memory 254 also includes machine executable instructions associated with the operation of the modules 261-265.

The CPU 204 is linked to modules for use in click filtering, including, for example, fraud detection, bot detection, malicious and suspicious click and traffic detection, Denial of Service (DoS) and Distributed Denial of Service (DDoS) attacks on web sites. The modules include, for example, a Fraud Detection module 261, a bot detection module 262, a malicious/suspicious clicks/traffic detecting module 263, a DoS/DDoS detector or detection module 264, a communications module 265, and a data base/storage media 266 for data including, for example, an IP blacklist, fraudulent clicks, detected bots and known malicious/suspicious clicks/traffic.

The fraud detection module 261 includes a submodule 261a for examining and analyzing click-associated parameters (also known as first parameters), such as parameters (also known as data parameters) associated with the click, for example, parameters of the device that has received the impression (whose activatable locations are “clicked” on). The examination and analysis of the click-associated parameters, for example, may be performed, prior to an activatable link in the impression being activated or “clicked” (prior to the “click”), as well as during and after the actual “click”. The submodule 261a also examines and analyzes 2) click parameters (also known as second parameters), which are parameters (also known as data parameters) of the actual click itself.

Click-associated parameters examined and analyzed by the inspection device 102 (module 261 and sub module 261a), which may be indicative of fraudulent, malicious, or suspicious clicks include, for example, campaign Identifier (ID) of the impression, the device which has received the impression and will or has transmitted the click, the operating system (OS) of the device which has received the impression and will or has transmitted the click, Java Script enabled (non-java script enabled devices may be sources of fraudulent, malicious, or suspicious clicks), Virtual Private Network (VPN)/Proxy in use, geographic date, e.g., country, city, region, continent, language (certain geographic locations and languages may be indicative of fraudulent, malicious, or suspicious clicks), browser types, internet service provider (ISP), IP, such as IP which has been blacklisted, Application ID, device/computer type (e.g., certain smart phone and/or computer models), channel ID of publisher/content provider (of the impression), and the like.

Click parameters examined and analyzed by the inspection device 102 (module 261 and sub module 261a), include, for example, click time (time stamp of click typically in terms of Coordinated Universal Time (UTC)), attributed time, e.g., if the user download an application after clicking on the impression, this is the time of the application download, and, target of the application (app) downloaded, and the like. The submodule 261a also examines the database 266, for blacklisted IPs and Uniform Resource Locators (URLs) and other data known to the system 200 to be fraudulent, as the database 266, for example, is constantly updated.

The Fraud Detection module 261, for example, also includes a rule and policies submodule 261b, which applies rules and policies to the various click-associated and click parameters, to determine whether the associated click is fraudulent. The click rules and policies are, for example, preprogrammed into the inspection device 102, but may be modified, or removed by the system administrator or the like,

Should the fraud detection module 261 detect fraudulent clicks or traffic from the parameter analysis, the associated clicks and/or traffic should not be allowed to reach the DNS server 122, and ultimately, not reach the intended destination. For example, via the communications module 265, the monitoring module 211 will be signaled to close the connections to the home server 100, and not allow the click or traffic to proceed forward, to the DNS server 122 and accordingly, not reaching its destination over the network(s) 50.

The bot detection module 262 detects whether clicks and/or traffic originated from bots and should not be allowed to reach the intended destination. This module 262 includes a behavior submodule 262a, which determines whether the click behavior is human or machine (e.g., bot) behavior, so as to be generated by a bot. The behavioral analysis submodule 262a, for example, analyzes click forms, to see if they are different from known or acceptable forms, checks to see whether the clicks are indicative of human behavior or machine behavior, for example, by looking at the time periods between clicks, multiple clicks on the same, or machine, e.g., bot behavior, which is not acceptable.

This module 262 includes a rules and policies submodule 262b, which applies rules and policies to various click behaviors, to also determine the presence or absence of a bot causing the click.

For example, should a bot be detected by the module 262, the communications module 265 will signal the monitoring module 211 to close the connections to the home server 100, and not allow the click or traffic to proceed to the DNS server 122 and/or its intended destination, such as target servers 120a-120n, over the network(s) 50.

The malicious/suspicious traffic module 263 includes a submodule 263a for signature detection of malicious/suspicious clicks and/or traffic. There is also a rules and policies submodule 263b for detecting malicious/suspicious traffic. For example, should malicious/suspicious clicks and/or traffic be detected by the module 263, the communications module 265 will signal the monitoring module 211 to close the connections to the home server 100, and not allow the click or traffic to proceed to the DNS server 122 and/or its intended destination, such as target servers 120a-120n, over the network(s) 50.

DoS/DDoS detector module 264 detects DoS and/or DDoS attacks at various points on the network(s) 50, including at one or more of the target servers. Should a DoS or DDoS attack be detected, the detector module 264 mitigates the attack by rerouting the traffic to mitigation servers (MS1-MSn) 124a-124n, until the attack subsides or ends. Should clicks be associated with traffic of a DoS or DDoS attack, the communications module 265 will signal the monitoring module 211 to close the connections to the home server 100, and not allow the click or traffic to proceed to the DNS server 122 and/or its intended destination, such as target servers 120a-120n, over the network(s) 50.

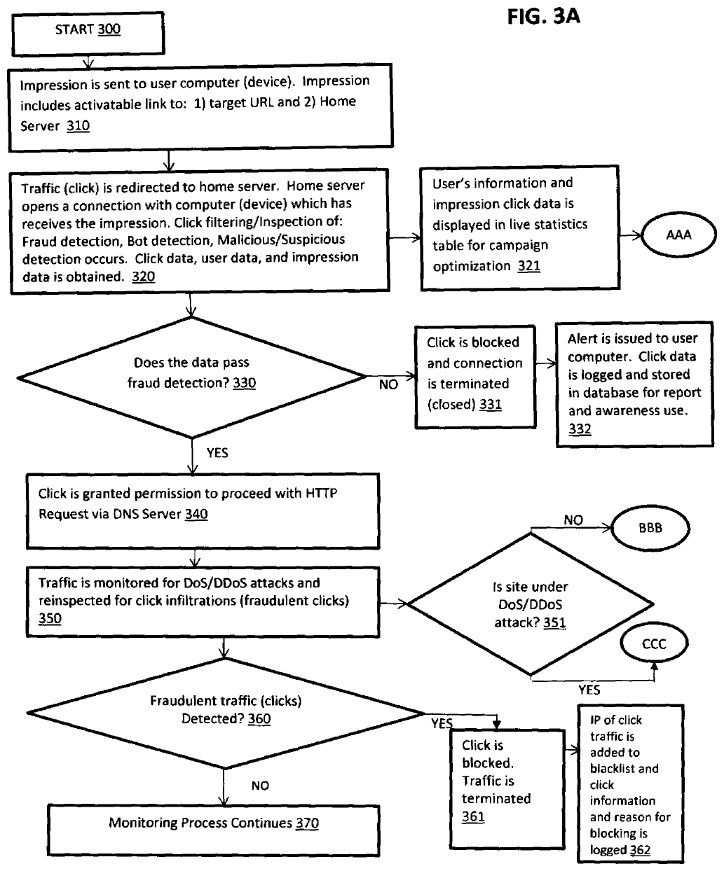

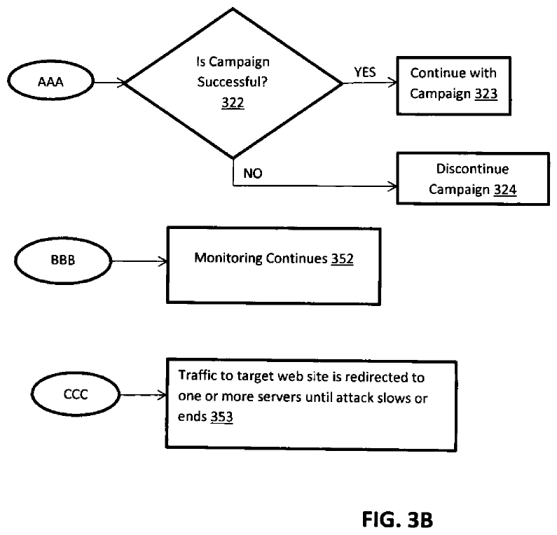

FIGS. 3A and 3B, collectively known hereinafter as FIG. 3, are a flow diagram of an example process. When describing the process, reference is made to the elements of FIGS. 1 and 2. The process is a computerized process and is, for example, performed automatically and in real time.

The process begins at a START block 300, where impressions for a campaign have been prepared to be sent in electronic communications, such as email, texts, WhatsApp messages, and other electronic communications. The impressions include one or more activatable links to at least the home server 100 and a target destination, for example, a target web site, hosted, for example, by target servers 120a-120n.

The process moves to block 310, where, for example, the sender server 104 sends an impression to an intended recipient, for example, smart phone 110 and its user 111. The impression is sent, for example, as an electronic communication, such as email, text and short message service (SMS), WhatsApp™ messages, Twitter™ messages, and other electronic and/or digital messages. The impression is active or opened, once the electronic communication has been activated or opened (e.g., by the click detailed below), for example, such that the impression displays on the screen or display of the computer/device 110, 114 of respective user 111, 115. As used herein, an “impression” is, for example, electronic and/or digital content, and includes, for example, a graphic or text with activatable portions, that when activated, by an activation on an activatable portion of the graphic, such as a box, or the like, or HTML link in text, cause an underlying link to become active and direct the browsing application of the computer/device to an intended (target) destination of the link, for example, mapped destinations, such as the home server 100, and destinations such as those represented by Uniform Resource Locators (URLs) such as the URL for one or more of the target servers 120a-120n. The aforementioned activation of the activatable portions of the impression includes, for example: 1) a touch, swipe or other contact, by a finger or other contact device, or, 2) mouse click or click by a pointing device, these aforementioned activations collectively referred to herein as a “click”. The result of the “click” on the activatable portion (activatable link or underlying activatable link) of the impression (e.g., opened or active impression) is referred to as a “click”, “click traffic” or “click and associated traffic”, these terms used interchangeably herein. When the activatable portion of the impression is activated, by the click, the underlying link is activated, and the browsing application of the device/computer which has received the impression is directed to the target or intended destination (e.g., home server 100/inspection device 102, and target servers T1 120a to Tn 120n), which are electronically linked to the activatable location of the impression. For example, when a web page is viewed by a user, it is defined as a “page impression”, while an advertisement, including the impression(s) detailed herein, when displayed on a computer/device screen, for example, is an “ad impression”.

Here, for example, the impression is mapped to the home server 100, and includes an activatable link(s) to: 1) an electronic destination, such as a target URL, for example, of a target server T1 120a to Tn 120n, and, 2) the home server 100 (e.g., by being mapped thereto). While a single impression is discussed here, this is exemplary only to detail the disclosed process, as one or more of the same impressions, or different impressions for the same information providing or advertising campaign, may be sent over the network(s) 50, by one or more sender servers 104 to intended recipients.

The impression in its electronic communication has now been transmitted from the sender server 104, and has reached the intended recipient's computer, where it is displayed, on the monitor, screen, or other display, and is active. The process is now at block 320. At block 320, the user has opened the electronic communication (for example, by a click, as detailed herein), such that the impression is now displayed and is active or opened. The home server 100 opens a connection to the device and the impression, as a result of the now opened and active impression being mapped to the home server 100. Alternately, the home server 100 could monitor the network(s) 50 for open impressions mapped to it. Through the now opened connection, the system 200, including, for example, the inspection device 102, will acquire parameters, in order to determine, for example: 1) whether the device computer that has received the impression is fraudulent (such that the associated click is fraudulent or not legitimate), and/or the activation or “click” on or associated with the received impression is fraudulent (such that the “click is not legitimate), such that any click or traffic associated with the click should not be sent on to a next destination, for example, a DNS server 122 for resolution to the intended URL 120a-120n, 2) conversion tracking of the click, and, 3) analytics for the click.

Fraud Detection

The home server 100, via the inspection device 102, will examine and typically also analyze, (e.g., through the open connection between the device and the home server) the device displaying the impression, and if there is a “click”, an activation of any of the activatable links, e.g., boxes in the graphics, HTML links in text, subjects the traffic associated with the “click” to filtering. The filtering is performed to determine whether a click and for example, associated traffic, is legitimate or not legitimate. The filtering includes, for example, fraud detection, bot detection, malicious/suspicious click and/or traffic detection, blocking certain URLs and/or Internet Protocols (IP), and other filtration processes, which may be programmed into the inspection device 102, by a system administrator or the like. Filtering may also be based on the applications of rules and policies to the traffic.

Example parameters analyzed by the fraud detection component (module 261) of the inspection device 102, include, for example, click-associated parameters and click parameters. Click-associated parameters examined by the inspection device 102 which may be indicative of fraudulent, malicious, or suspicious clicks include, for example, campaign Identifier (ID) of the impression, the device which has received the impression and will or has transmitted the click, the operating system (OS) of the device which has received the impression and will or has transmitted the click, Java Script enabled (non-java script enabled devices may be sources of fraudulent, malicious, or suspicious clicks), Virtual Private Network (VPN)/Proxy in use, geographic date, e.g., country, city, region, continent, language (certain geographic locations and languages may be indicative of fraudulent, malicious, or suspicious clicks), browser types, internet service provider (ISP), IP, such as IP which has been blacklisted, Application ID, device/computer type (e.g., certain smart phone and/or computer models), channel ID of publisher/content provider (of the impression), and the like.

Click parameters include, for example, click rules and policies, which are typically preprogrammed into the inspection device 102, but may be modified, or removed by the system administrator or the like, click time (time stamp of click typically in terms of Coordinated Universal Time (UTC)), attributed time, e.g., if the user download an application after clicking on the impression, this is the time of the application download, and, target of the application (app) downloaded, and the like.

Other click indicators include bot detection (bot detection module 262), for example by behavior detection, by the behavioral analysis submodule 262a. The behavioral analysis submodule 262a analyzes click forms, to see if they are different from known or acceptable forms, checks to see whether the clicks are indicative of human behavior or machine behavior, for example, by looking at the time periods between clicks, multiple clicks on the same, or non-human, e.g., bot behavior, which is not acceptable.

Still other click indicators include detection of malicious/suspicious clicks and traffic by module 263 and sub modules 263a, 263b, specifically analyzing the activatable link(s) in the impression, looking to the origin of the clicks (e.g., where the clicks came from), as well as other behavioral aspects of the clicks, that may indicate human behavior, which is acceptable, designed to detect signatures of malicious or suspicious clicks and associated traffic, and/or apply rules and policies (submodule 263b), to detect signatures (submodule 263a) of malicious or suspicious clicks and associated traffic.

Conversion and Tracking and Analytics Parameters

From block 320, the process moves to block 321, where the information on the user, who received the impression, and his device, on which the electronic communication with the impression was received, and is now displayed, and data associated with the user's activation, e.g., “click”, is, for example, displayed in a live statistics table for optimization of the information providing or advertising campaign. The home server 100, via the system 200, is also collecting user, impression and click data, as conversion and tracking parameters, and analytics parameters.

Conversion tracking parameters, for example, for a campaign associated with the sent impressions, include, for example, Average Cost Per Click (CPC), the actual average price a content provider (for the impression) pays for each click on the impression, Average position for the click, clicks per a time period, such as clicks per day, click through rate, the number of clicks that reach their intended target, impressions per a specific time period, such as impressions sent per day, total cost to the impression/content provider, start date for the campaign and the impressions associated therewith to be sent to intended recipients, budget for a time period, such as daily budget, estimated total conversions, conversion value, sign ups, click to call (from a call activation of the impression), cost per thousand impressions or cost per mille (thousand) (cpm), and the like.

Analytics parameters, analyzed, for example, by the analytics and statistics module 214, include, for example, traffic for a time period, e.g., hour/day/week/month, total time a user spends browsing the impression and any target web sites associated therewith, time spent on each page, internal click links, calls originating from clicks on the impression, unique visitors, web hits, clicks by countries, clicks by operating systems, clicks by browsers, most viewed impression, click on engagement of an impression, URL clicks, click source, and the like.

From block 320, the process moves to block 321, where the information on the user, who received the impression, and his device, on which the electronic communication with the impression was received, and is now displayed, and data associated with the user's activation, e.g., “click”, is, for example, displayed in a live statistics table for optimization of the information providing or advertising campaign.

The process moves to block 322, where the information provider or advertiser can view the live statistics on an on-line accessible dashboard (provided by module 215), and either manually or automatically, via analytics, can determine whether the campaign for which the impressions were sent to recipients, was successful. If yes, the process moves to block 323, where the campaign continues, and the sender server 104 continues to send impressions to recipients. If no at block 322, the process moves to block 324, where the campaign is discontinued, and ends, with no more impressions being sent.

Returning to block 320, the process moves to block 330, where it is determined whether the click is not fraudulent, so as to be legitimate, as it has passed the specified inspection of click-associated and click parameters/data for being fraudulent. Should the click-associated parameters and/or click parameters/data, be fraudulent or otherwise suspicious or malicious, rendering the click as not legitimate, the process moves to block 331, where the click is blocked, and any connections between the device which has received the impression and the home server 100 is closed, such that the click never reaches the target destination of the impression (activatable link(s)), and typically the DNS server 122, prior to the target destination. From block 331, the process moves to block 332, where, for example, an alert (from the alert module 216) is issued to the device, that the browser will not be redirected to the target destination (e.g., URL associated with a target server 120a-120n, and the click data is logged in a click log 213 and stored in a data base 218 for reporting as fraudulent and for awareness use.

Returning to block 330, the click is legitimate, and the process moves to block 340. At block 340, the click is granted permission to proceed with the associated Hypertext Transfer Protocol (HTTP) via the DNS server 122. From the DNS server, the URL for the click is resolved, such that the click causes redirection of the browser of the computer/device 110, 114 to the target destination, e.g., the URL associated with an intended destination target web server 120a-120n.

Prior to the aforementioned browser redirection, the process moves from block 340 to block 350, where the traffic associated with the click is monitored for malicious Denial of service (DoS) and Distributed Denial of Service (DDoS) attacks, and click infiltrations (fraudulent or potentially fraudulent, malicious, or suspicious clicks) that may have passed through at block 330. DoS and DDoS attacks are detected by the DoS/DDoS detector module 264, while the click and its associated traffic are checked for fraud by an analysis in accordance with one or more of the parameters for fraud listed above.

The process moves from block 350 to block 351, where it is determined whether the intended target server 120a-120n is under a DoS or DDoS attack, for example, by traffic monitoring. If yes, the process moves to block 352, where the traffic is directed to one or more mitigation servers (MS) 124a-124n until the DoS or DDoS attach has ended or subsided. If no, the process moves to block 353, where the monitoring for DoS and DDoS attacks continues.

Returning to block 350, the clicks are again inspected (e.g., reinspected), for example, for being fraudulent or otherwise not legitimate, and the process moves to block 360. At block 360, the system 200 determines whether the click and associated traffic are fraudulent, malicious or suspicions, and otherwise not legitimate. This determination is made, for example, by applying one or more of the fraud detection parameters, in a reinspection process by the inspection device 102, similar to the inspection (click filtration/examination/analysis) process detailed above. Additionally, for example, one or more of bot detections are performed by module 262, as well as the performance of behavioral analysis of the clicks of the traffic by the behavior analysis submodule 262a. The behavior analysis submodule 262a analyzes click forms, to see if they are different from known or acceptable forms, checks to see whether the clicks are indicative of human behavior or machine behavior, for example, by looking at the time periods between clicks, multiple clicks on the same activatable link in the impression, looking to the origin of the clicks (e.g., where the clicks came from), as well as other behavioral aspects of the clicks, that may indicate human behavior, which is acceptable, or non-human, e.g., bot behavior, which is not acceptable.

If yes at block 360, the process moves to block 361, where the click is terminated (blocked) and traffic is cut off (blocked and/or terminated), so as not to reach the intended destination, as the click was determined to be not legitimate. The process moves from block 361 to block 362, where the IP address associated with the click traffic is added to an IP black list and the data associated with the click and associated traffic is logged into the click log along with the reason for the blocking of the click and the associated traffic.

If no at block 360, the click is legitimate and is now suitable for resolution by the DNS server 122. Once resolved by the DNS server 122, the click reaches the intended destination and the browser of the user computer is redirected to the intended destination, such as one or more of the target servers 120-120n in accordance with the click.

The process moves to block 370, where the monitoring of clicks and traffic continues for as long as desired, and the process may resume from the START block 300 for another cycle or as many cycles as desired.

Other embodiments include a computerized method for filtering traffic associated with clicks, the clicks associated with activatable links in electronic content, such as impressions, including, for example, advertisements. The computerized method comprises: opening a connection between a recipient computer, such as a smart phone, desktop computer or the like, of a user, the recipient computer having received and opened the electronic content in an electronic communication, and, an inspection computer; the inspection computer analyzing data parameters associated with the recipient computer and the click associated with the activation of an activatable link, to determine whether the click is legitimate; should the click be not legitimate, the click is blocked and the connection is terminated; and, should the click be legitimate, allowing the click to cause a browser associated with the recipient computer to be redirected to a target destination of the activatable link.

Optionally, the computerized method is such that the browser redirection includes causing the click to be processed by a Domain Name server to resolve an address of the target destination. Optionally, the computerized method is such that the electronic content is mapped to the inspection computer. Optionally, the computerized method is such that the electronic content includes an impression with activatable portions including the activatable links, the activatable links for destinations including the inspection server and the target destination. Optionally, the computerized method is such that the click includes electronic traffic. Optionally, the computerized method is such that the electronic communication includes: email, text messages, short message service messages (SMS), WhatsApp™ messages, Twitter™ messages, and other electronic and/or digital messages.

Other embodiments include a computer system for filtering traffic associated with clicks, the clicks associated with activatable links in electronic content. The computer system comprises: a computerized module for opening a connection between a recipient computer including the electronic content having been opened from an electronic communication, and, an inspection computer; and, an inspection computer for analyzing data parameters associated with the recipient computer and the click associated with the activation of an activatable link, to determine whether the click is legitimate, the inspection computer causing blocking of the click and terminating of the connection, should the click be not legitimate, and causing a browser associated with the recipient computer to be redirected to a target destination of the activatable link.

Optionally, the computer system is such that the inspection computer causing the browser redirection includes causing the click to be processed by a Domain Name server to resolve an address of the target destination. Optionally, the computer system is such that the electronic content is mapped to the inspection computer. Optionally, the computer system is such that the electronic content includes an impression with activatable portions including the activatable links, the activatable links for destinations including the inspection server and the target destination. Optionally, the computer system is such that the click includes electronic traffic. Optionally, the computer system is such that the electronic communication includes: email, text messages, short message service messages (SMS), WhatsApp™ messages, Twitter™ messages, and other electronic and/or digital messages.

Other embodiments include a computerized method for filtering traffic associated with clicks, the clicks associated with activatable links in electronic content, such as impressions, including, for example, advertisements. The computerized method comprises: opening a connection between a recipient computer, such as a smart phone, desktop computer or the like, of a user, the recipient computer having received and opened the electronic content in an electronic communication, and, an inspection computer; the inspection computer analyzing data parameters associated with the recipient computer and the traffic caused by the click on the activatable link in the electronic content, to determine whether the traffic is legitimate; should the traffic be not legitimate, the traffic is blocked and the connection is terminated; and, should the traffic be legitimate, causing a browser associated with the recipient computer to redirect the traffic to a target destination of the activatable link.

Optionally, the computerized method is such that the browser redirection includes causing the traffic to be processed by a Domain Name server to resolve an address of the target destination. Optionally, the computerized method is such that the electronic content is mapped to the inspection computer. Optionally, the computerized method is such that the electronic content includes an impression with activatable portions including the activatable links, the activatable links for destinations including the inspection server and the target destination. Optionally, the computerized method is such that the electronic communication includes: email, text messages, short message service messages (SMS), WhatsApp™ messages, Twitter™ messages, and other electronic and/or digital messages.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A computerized method for filtering traffic associated with clicks, the clicks associated with activatable links in electronic content, comprising:
opening a connection between a recipient computer including the electronic content having been opened from an electronic communication, and, an inspection computer;
the inspection computer analyzing data parameters associated with the recipient computer and the click associated with the activation of an activatable link, to determine whether the click is legitimate;
should the click be not legitimate, the click is blocked and the connection is terminated; and,
should the click be legitimate, allowing the click to cause a browser associated with the recipient computer to be redirected to a target destination of the activatable link.

2. The computerized method of claim 1, wherein the browser redirection includes causing the click to be processed by a Domain Name server to resolve an address of the target destination.

3. The computerized method of claim 1, wherein the electronic content is mapped to the inspection computer.

4. The computerized method of claim 3, wherein the electronic content includes an impression with activatable portions including the activatable links, the activatable links for destinations including the inspection server and the target destination.

5. The computerized method of claim 1, wherein the click includes electronic traffic.

6. The computerized method of claim 1, wherein the electronic communication includes: email, text messages, short message service messages (SMS), WhatsApp™ messages, Twitter™ messages, and other electronic and/or digital messages.

7. A computer system for filtering traffic associated with clicks, the clicks associated with activatable links in electronic content, comprising:
a computerized module for opening a connection between a recipient computer including the electronic content having been opened from an electronic communication, and, an inspection computer; and,
an inspection computer for analyzing data parameters associated with the recipient computer and the click associated with the activation of an activatable link, to determine whether the click is legitimate, the inspection computer causing blocking of the click and terminating of the connection, should the click be not legitimate, and causing a browser associated with the recipient computer to be redirected to a target destination of the activatable link.

8. The computer system of claim 7, wherein the inspection computer causing the browser redirection includes causing the click to be processed by a Domain Name server to resolve an address of the target destination.

9. The computer system of claim 7, wherein the electronic content is mapped to the inspection computer.

10. The computer system of claim 9, wherein the electronic content includes an impression with activatable portions including the activatable links, the activatable links for destinations including the inspection server and the target destination.

11. The computer system of claim 7, wherein the click includes electronic traffic.

12. The computer system of claim 7, wherein the electronic communication includes: email, text messages, short message service messages (SMS), WhatsApp™ messages, Twitter™ messages, and other electronic and/or digital messages.

13. A computerized method for filtering traffic associated with clicks, the clicks associated with activatable links in electronic content, comprising:
opening a connection between a recipient computer including the electronic content having been opened from an electronic communication, and, an inspection computer;
the inspection computer analyzing data parameters associated with the recipient computer and the traffic caused by the click on the activatable link in the electronic content, to determine whether the traffic is legitimate;
should the traffic be not legitimate, the traffic is blocked and the connection is terminated; and,
should the traffic be legitimate, causing a browser associated with the recipient computer to redirect the traffic to a target destination of the activatable link.

14. The computerized method of claim 13, wherein the browser redirection includes causing the traffic to be processed by a Domain Name server to resolve an address of the target destination.

15. The computerized method of claim 13, wherein the electronic content is mapped to the inspection computer.

16. The computerized method of claim 15, wherein the electronic content includes an impression with activatable portions including the activatable links, the activatable links for destinations including the inspection server and the target destination.

17. The computerized method of claim 13, wherein the electronic communication includes: email, text messages, short message service messages (SMS), WhatsApp™ messages, Twitter™ messages, and other electronic and/or digital messages.
